(19) United States
(12) Patent Application Publication
(10) Pub. No.: US 2016/0233068 A1
(43) Pub. Date: Aug. 11, 2016

(54) SAMPLE COLLECTION WAND COMPRISING AN INDUCTIVELY COUPLED HEATER

(71) Applicants: Paul ARNOLD, Besfordshire (GB); Lee PIPER, Hertordshire (GB); Alex HILEY, Surrey (GB)

(72) Inventors: Paul Arnold, Bedfordshire (GB); Lee Piper, Hertfordshire (GB); Alex Hiley, Surrey (GB)

(21) Appl. No.: 15/023,090

(22) PCT Filed: Sep. 19, 2014
(86) PCT No.: PCT/GB2014/052864

§ 371 Date: Mar. 18, 2016

(30) Foreign Application Priority Data
Sep. 19, 2013 (GB) 1316671.5

(51) Int. Cl. H01J 49/04

(52) U.S. Cl. CPC H01J 49/049; H01J 49/0409

(57) ABSTRACT

A spectrometry apparatus comprising a spectrometer; a port adapted to couple a sample collection wand to the apparatus to present a sample carried by the wand to an inlet of the spectrometer; and an inductive coupler adapted to couple, via a time varying H-field, with a heater of said sample collection wand to provide electrical power for heating said sample.

The present disclosure relates to methods and apparatus for the detection of substances of interest. More particularly the disclosure relates to methods and apparatus for the thermal desorption of samples for example to enable analysis to detect substances of interest in the samples. Analysis may be performed using spectrometers, such as ion mobility spectrometers and/or mass spectrometers.

In facilities such as airports and venues where large numbers of people may gather, there is a need to detect traces of substances of interest such as explosives.

One way to detect such substances is to obtain a sample from a surface using a sample collection wand, and then heating the sample to thermally desorb it to be tested for the presence of substances of interest.

Embodiments of the disclosure will now be described, by way of example only, with reference to the accompanying drawings in which:

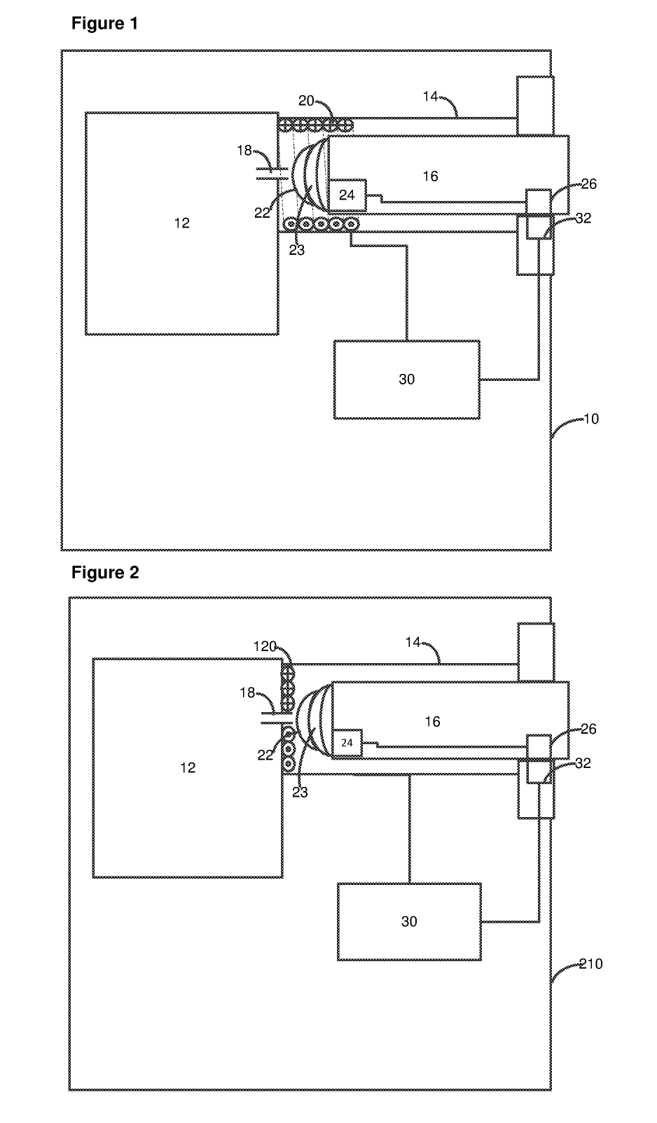

FIG. 1 shows a spectrometer with an inductive coupler for providing inductive coupling with a heater of a sample collection wand;

FIG. 2 shows another spectrometer with an inductive coupler for providing inductive coupling with a heater of a sample collection wand;

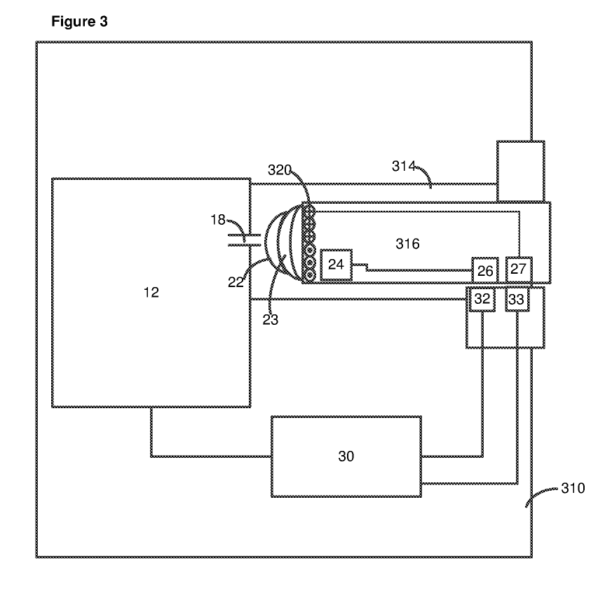

FIG. 3 shows another spectrometer with a sample collection wand including an inductive coupler.

In the drawings like reference numerals are used to indicate like elements.

Embodiments of the disclosure provide spectrometers such as ion mobility spectrometers in which an inductive coupler is arranged to couple, via a time varying magnetic field (H-field), with a heater to provide electrical power for thermally desorbing a sample to enable it to be analysed in the spectrometer. The use of inductive coupling to supply power to the heater may enable the heater to be efficiently thermally insulated from supporting structures, such as a sample collection wand.

In addition, it may enable the use of wands which do not comprise heaters because a swab comprising an electrical conductor may function as a heater.

The inductive coupler may be carried by the spectrometer for example in a port adapted to couple with a sample collection wand, as illustrated in FIG. 1 and FIG. 2. For example the inductive coupler may be arranged adjacent to an inlet of the spectrometer for coupling with a heater carried by a sample collection wand that presents a sample to the inlet. As illustrated in FIG. 3, in some examples the inductive coupler may be carried by a sample collection wand and a conductive coupling may be carried on the wand body to couple the inductive coupler with a power supply of the spectrometer. The conductive coupling can be arranged so that when the sample collection wand is inserted into a port of the spectrometer, power can be provided to the inductive coupler from the spectrometer.

FIG. 1 shows a spectrometry apparatus 10 comprising an ion mobility spectrometer 12 for analysing a sample. The apparatus shown in FIG. 1 comprises a port 14 adapted to couple a sample collection wand 16 to the apparatus. As illustrated, an inlet 18 of the spectrometer 12 is arranged in a wall of the port 14 for enabling a sample that has been thermally desorbed from the wand 16 to be drawn through the inlet 18 into the spectrometer 12.

The port 14 of the apparatus shown in FIG. 1 is arranged so that, when a sample collection wand 16 is coupled to the port 14, the wand 16 presents a sample carried by the wand 16 to an inlet 18 of the spectrometer 12.

As illustrated in FIG. 1, the spectrometry apparatus 10 comprises an inductive coupler 20 adapted to provide a magnetic field (H-field) in the port for coupling with a heater 22 of the sample collection wand 16 to provide electrical power to the heater 22. The inductive coupler may comprise a conductor arranged to provide a time varying magnetic field (H-field) such as a radio frequency, RF, field.

The inductive coupler 20 carried by the port 14 can be arranged to provide a magnetic field (H-field) in the port 14 for coupling with a heater 22 carried by the sample collection wand 16. As shown in FIG. 1, the inductive coupler 20 can be arranged to at least partially surround the heater 22 when, in use, the wand 16 is inserted into the port 14 to present a sample to the inlet 18 of the spectrometer. In the example illustrated in FIG. 1, the inductive coupler 20 comprises a cylindrical inductor arranged so that the wand 16 can carry the heater 22 into a region at least partially surrounded by the inductive coupler 20 to present the sample to the inlet 18. The dashed lines in FIG. 2 illustrate one possible configuration of a conductor, e.g. as a helical coil, to provide an inductive coupler 20.

The wand 16 may comprise a temperature sensor 24 for sensing the temperature of the wand 16 near the heater 22, and a coupling 26 for providing communication to the sensor 24. The apparatus 10 may comprise a controller 30 configured to obtain temperature signals from the sensor 24 via the couplings 26, 32. The controller 30 may also be configured to control the inductive coupler 20 for providing power to the heater 22. The temperature sensor 24 may comprise any sensor for providing a signal based on temperature such as a thermocouple or thermistor.

The sample collection wand 16 illustrated in FIG. 1 comprises a wand body of a size selected to enable convenient manipulation of the wand 16, and a swab support 23 coupled to the wand body for supporting a swab upon which a sample can be collected. The wand 16 shown in FIG. 1 also comprises a heater 22 for heating a swab carried on the swab support 23. The heater 22 is arranged to receive power by inductively coupling with a magnetic field (H-field) provided by an inductive coupler 20 of a spectrometry apparatus 10. This may enable the heater 22 to be electrically isolated from the wand 16 on the swab support 23. This may in turn provide thermal isolation of the heater 22 from the wand 16.

As illustrated in FIG. 1, the wand 16 may comprise a swab support 23 for supporting a swab for collecting a sample. The support may be configured to thermally insulate a swab from the wand 16. In some embodiments the swab support 23 may comprise the heater 22. In some embodiments a swab used to collect the sample may itself comprise the heater 22, for example, if the swab comprises an electrical conductor the magnetic field (H-field) of the inductive coupler can couple with the conductors of the swab to heat a sample carried on the swab. One example of a swab comprising a conductor is a metallised swab.

FIG. 2 shows another example of a spectrometry apparatus 210. In the example shown in FIG. 2 the spectrometry apparatus also comprises an ion mobility spectrometer 12, and, similar to the apparatus shown in FIG. 1, the apparatus of FIG. 2 comprises a port 14 adapted to couple a sample collection wand 16 to the apparatus 210. As illustrated, an inlet 18 of the spectrometer 12 is arranged in a wall of the port 14 for enabling a sample that has been thermally desorbed from the wand 16 to be drawn through the inlet 18 into the spectrometer 12. Also as illustrated in FIG. 1, the port 14 of the apparatus 210 shown in FIG. 2 is arranged so that, when a sample collection wand 16 is coupled to the port 14, the wand 16 presents a sample carried by the wand 16 to an inlet 18 of the spectrometer 12.

The inductive coupler 120 shown in FIG. 2 may be carried by the same wall of the port 14 as the inlet 18 of the spectrometer 12, and may at least partially surround the inlet 18. The port 14 is arranged so that, when the wand 16 is inserted into the port 14, the heater 22 is close enough to the inductive coupler 120 that the magnetic field (H-field) generated by the inductive coupler 120 can cause heating currents in the heater 22.

In operation of the apparatus shown in FIG. 1 or FIG. 2, a swab is used to collect a sample by rubbing the swab against a surface. The wand 16 can then be inserted into the port 14 carrying the swab on the heater 22. To provide electrical power to the heater 22, the controller 30 controls the inductive coupler (20 in FIG. 1; 120 in FIGS. 2) to provide a time varying magnetic field (H-field) in the port 14. As the heat capacity of the heater 22 can be very small, and the heater can be thermally and electrically isolated from the wand body, the temperature of the sample can be raised rapidly to thermally desorb the sample from the swab. Rapid desorption of the sample is desirable because where substances are desorbed rapidly the concentration of substances available for analysis by the spectrometer may be increased. By contrast, if the temperature of the sample is raised more slowly the substances may be present at the inlet for a greater period of time, but in lower concentration. The controller 30 may obtain a signal from the sensor 24 indicating the temperature of the heater 22 and control the power provided by the inductive coupler 20, 120 based on the signal from the sensor 24.

FIG. 3 shows a further example of a spectrometry apparatus 310. As shown in FIG. 3, the sample collection wand 16 may comprise an inductive coupler 320 arranged to couple inductively with a heater 22 carried on the wand to provide electrical power to the heater 22.

The spectrometry apparatus of FIG. 3 comprises an ion mobility spectrometer 12, and, similar to the apparatus shown in FIG. 1, the apparatus of FIG. 3 comprises a port 314 adapted to couple a sample collection wand 316 to the apparatus 310. As illustrated, an inlet 18 of the spectrometer 12 is arranged in a wall of the port 314 for enabling a sample that has been thermally desorbed from the wand 316 to be drawn through the inlet 18 into the spectrometer 12.

The port 314 of the apparatus 310 shown in FIG. 3 is arranged so that, when a sample collection wand 316 is coupled to the port 314, the wand 316 presents a sample carried by the wand 316 to an inlet 18 of the spectrometer 12 to enable the sample to be desorbed and collected by the inlet 18. In addition, the port 314 comprises a coupling 33 for providing electrical power to the sample collection wand 316. The coupling 33 can be arranged so that electrical power can only be provided to the wand 316 when the wand is positioned to enable substances thermally desorbed from the wand 316 to be drawn through the inlet 18 into the spectrometer 12. The coupling 33 may comprise a conductive coupling or a capacitive coupling adapted to couple an alternating current to a corresponding coupling 27 carried by the sample collection wand. The alternating current may comprise a radio frequency, RF, current.

The sample collection wand 316 shown in FIG. 3 comprises a coupling 27 carried on the wand 316 so that, when the wand is inserted into a port 314 of the spectrometry apparatus 310 the coupling 27 cooperates with the coupling 33 of the apparatus 310 to enable the controller 30 to provide electrical power to the inductive coupler 320 carried by the sample collection wand.

In operation of the apparatus shown in FIG. 3, a swab is used to collect a sample by rubbing the swab against a surface. The wand 316 can then be inserted into the port 314 carrying the swab on the heater 22. To provide electrical power to the heater 22, the controller 30 can provide a time varying current to the coupling 33, so that when the wand 316 is inserted into the port 314, the coupling 33 of the port 314 and the coupling 27 of the wand 316 are arranged to pass an alternating current to the inductive coupler 320. The magnetic field (H-field) generated by the inductive coupler 320 can heat the heater 22 to thermally desorb the sample for collection by the inlet.

In some embodiments the heater 22 comprises a ferromagnetic material. This may improve the efficiency of energy transfer via the H-field to the heater 22 because of the reduction in skin depth provided by ferromagnetism. In addition it may enable temperature control of the heater 22 to be provided by the Curie point of the ferromagnetic material because, in the event that the heater 22 is heated beyond its Curie point, the heater will lose at least some of its ferromagnetic order, and the skin depth of the heater may be modified.

As will be appreciated by the skilled reader in the context of the present disclosure, each of the examples described herein may be implemented in a variety of different ways. Any feature of any aspects of the disclosure may be combined with any of the other aspects of the disclosure. For example method aspects may be combined with apparatus aspects, and features described with reference to the operation of particular elements of apparatus may be provided in methods which do not use those particular types of apparatus. In addition, each of the features of each of the embodiments is intended to be separable from the features which it is described in combination with, unless it is expressly stated that some other feature is essential to its operation. Each of these separable features may of course be combined with any of the other features of the embodiment in which it is described, or with any of the other features or combination of features of any of the other embodiments described herein.

The controller 30 may be provided by any control apparatus such as a general purpose processor configured with a computer program product configured to program the processor to operate according to any one of the methods described herein. In addition, the functionality of the controller 30 may be provided by an application specific integrated circuit, ASIC, or by a field programmable gate array, FPGA, or by a configuration of logic gates, or by any other control apparatus.

1. A spectrometry apparatus comprising:
a spectrometer;
a port configured to couple a sample collection wand to the apparatus to present a sample carried by the wand to an inlet of the spectrometer; and
an inductive coupler configured to couple, via a time varying H-field, with a heater of said sample collection wand to provide electrical power for heating said sample.

2. The spectrometry apparatus of claim 1, in which the inductive coupler is configured to provide the time varying H-field in the port to couple with said heater.

3. The spectrometry apparatus of claim 2, in which the inductive coupler is configured to at least partially surround said heater when, in use, said sample collection wand is coupled to the port.

4. The spectrometry apparatus of claim 2, in which the inlet of the spectrometer provides fluid communication between the port and the spectrometer and the inductive coupler at least partially surrounds the inlet.

5. The spectrometry apparatus of claim 1, further comprising the sample collection wand, wherein the sample collection wand comprises the inductive coupler.

6. The spectrometry apparatus of claim 5, in which the sample collection wand comprises a heater for heating a sample collected by the wand, wherein the heater is electrically isolated on the wand.

7. The spectrometry apparatus of claim 6, in which the wand comprises a support for supporting a swab for collecting a sample wherein the support is configured to thermally insulate the swab from the wand.

8. The spectrometry apparatus of claim 7, in which the support comprises the heater.

9. The spectrometry apparatus of claim 7, further comprising the swab, in which the swab comprises the heater.

10. A sample collection wand for a spectrometry apparatus, the wand comprising:
a wand body configured to enable manipulation of the wand;
a swab support coupled to the wand body; and
a heater for heating a swab carried on the swab support, wherein the heater is configured to receive power by inductive coupling to an H-field provided by an inductive coupler of a spectrometry apparatus.

11. The sample collection wand of claim 10, in which the heater is electrically isolated on the swab support.

12. The sample collection wand of claim 10, further comprising an inductive coupler configured to couple inductively with the heater to provide electrical power to the heater.

13. The sample collection wand of claim 10, in which the swab support comprises the heater.

14. The sample collection wand of claim 10, further comprising a swab, wherein the swab comprises the heater.

15. A sample collection wand for a spectrometry apparatus, the wand comprising:
a wand body configured to enable manipulation of the wand;
a swab support coupled to the wand body; and
an inductive coupler configured to couple inductively with a heater to provide electrical power to the heater for heating a swab carried on the swab support.

16. The sample collection wand of claim 15, having a conductive coupling carried on the wand body wherein the conductive coupling is configured to couple with an electrical power supply of a spectrometry apparatus when, in use, the wand is inserted into a port of the spectrometry apparatus for providing a power supply to the inductive coupler.

17. The sample collection wand of claim 15, further comprising said heater, wherein the heater is configured to receive electrical power by coupling inductively with an H-field provided by the inductive coupler of the sample collection wand.

18. The sample collection wand of claim 15, in which the heater comprises a ferromagnetic material.

19. The sample collection wand of claim 15, in which the swab support comprises the heater.

20. The sample collection wand of claim 15, further comprising a swab, wherein the swab comprises the heater.
